(19) United States
(12) Patent Application Publication
(10) Pub. No.: US 2014/0111506 A1
(43) Pub. Date: Apr. 24, 2014

(54) Pixel Circuit, Method For Driving The Same, Display Device And Display Method

(71) Applicant: BOE Technology Group Co., Ltd., Beijing (CN)

(72) Inventors: Mi Zhang, Beijing (CN); Yun Sik Im, Beijing (CN)

(73) Assignee: BOE Technology Group Co., Ltd., Beijing (CN)

(21) Appl. No.: 13/980,720

(22) PCT Filed: Dec. 11, 2012
(86) PCT No.: PCT/CN2012/086320

§ 371 Date: Jan. 9, 2014

(30) Foreign Application Priority Data
Feb. 28, 2012 (CN) 201210048572.8

(51) Int. Cl. G09G 3/20

(52) U.S. Cl. CPC G09G 3/20
USPC 345/215; 315/172

(57) ABSTRACT

A pixel circuit comprising a plurality of pixel units, wherein each pixel unit comprises a data line (50), a charge gate line (40), a common electrode line (60), a cache module (10), a pixel circuit module (20), and a common gate line (30); the cache module (10) is connected to the charge gate line (40) that supplies a control signal for the cache module (10); an input of the cache module (10) is connected to the data line (50), at the time of supplying a enable control signal by the charge gate line (40), the cache module (10) receives and stores a display signal supplied by the data line (50); the pixel circuit module (20) is connected to the common gate line (30) that supplies a control signal for the pixel circuit module (20); an output of the cache module (10) is connected to an input of the pixel circuit module (20), at the time of supplying an enable control signal by the common gate line (30), the display signal stored in the cache module (10) is written into the pixel circuit module (20).

### TECHNICAL FIELD

The embodiments of the invention relate to a pixel circuit, a driving method of the pixel circuit, a display device and a display method.

### BACKGROUND

In an existing pixel circuit, as shown in FIG. 1, the pixel circuit comprises thin film transistors (TFTs) corresponding to the respective pixel units. The pixel unit in prior art comprises: a charge gate line 4, a common electrode line 3, a data line 5, a TFT, and a capacitor C; wherein the capacitor C specifically comprises a pixel capacitor (Cpixel) and a common capacitor (Cst); specifically, a gate electrode of the TFT is connected to the charge gate line 4 that supplies a control signal for the TFT; a source electrode of the TFT is connected to the data line 5 that supplies a display signal for the TFT; a drain electrode of the TFT is connected to one end of the capacitor C, and when an activate signal is supplied for the TFT by the charge gate line 4, the source and the drain electrodes of the TFT are electrically conducted, and the display signal from the data line 5 is input to the capacitor C through the TFT; the other end of the capacitor C is connected to the common electrode line 3 that supplies a constant voltage signal for the capacitor C, so that the current display signal can be maintained until the next scan is performed.

A progressive scan method is an existing conventional method of driving a pixel circuit, in which the scan is started from a first charge gate tine, a second charge gate line, a third charge gate line . . . to a last charge gate line sequentially. In the existing pixel circuit, the display signals in a data line driver chip (IC) are written into the capacitor C of the pixel circuit through the data lines so as to be displayed. When an image is displayed, the scan is started from the first charge gate line, the second charge gate line, the third charge gate line . . . to the last charge gate line sequentially, so as to form a one frame image. The scan for the next frame is also started from the first charge gate line. Thus, in displaying the pixels of the first and the last charge gate lines, there may be a certain time difference. Therefore, in a scan period of one frame, a time difference of approximate one frame may exist between the first and the last charge gate lines when they are scanned. That is, the pixel units that correspond to the respective first and last gate lines will display the image individually, rather than simultaneously display a complete one frame image, so the images cannot be displayed smoothly, and the display quality of 3D or moving images cannot be guaranteed.

### SUMMARY

According to an embodiment of the invention, there is provided a pixel circuit, comprising a plurality of pixel units, wherein each pixel unit comprises a data line, a charge gate line, a common electrode line, a cache module, a pixel circuit module, and a common gate line; the cache module is connected to the charge gate line that supplies a control signal for the cache module; an input of the cache module is connected to the data line, at the time of supplying a enable control signal by the charge gate line, the cache module receives and stores a display signal supplied by the data line; the pixel circuit module is connected to the common gate line that supplies a control signal for the pixel circuit module; an output of the cache module is connected to an input of the pixel circuit module, at the time of supplying a enable control signal by the common gate line, the display signal stored in the cache module is input to the pixel circuit module.

According to another embodiment of the invention, there is provided a driving method of the above-described pixel circuit, comprising: charging the cache module of the respective pixel units sequentially, and simultaneously storing the display signal input by the data line in the cache module; and after the charge for all the cache modules is completed, activating the common gate line, inputting the display signal stored in the cache module to the pixel circuit module of each pixel unit, and displaying.

According to yet another embodiment of the invention, there is provided a display device, comprising the above-described pixel circuit.

According to still another embodiment of the invention, there is provided a display method of a display device, comprising the above-described driving method.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 shows a structure of each pixel unit in a pixel circuit in prior art;

FIG. 2 shows a structure of each pixel unit in a pixel circuit according to an embodiment of the invention;

FIG. 3 shows an explanative structure of each pixel unit in a pixel circuit according to an embodiment of the present invention; and

FIG. 4 shows a relationship of a common gate line and a charge gate line in a pixel circuit according to an embodiment of the present invention.

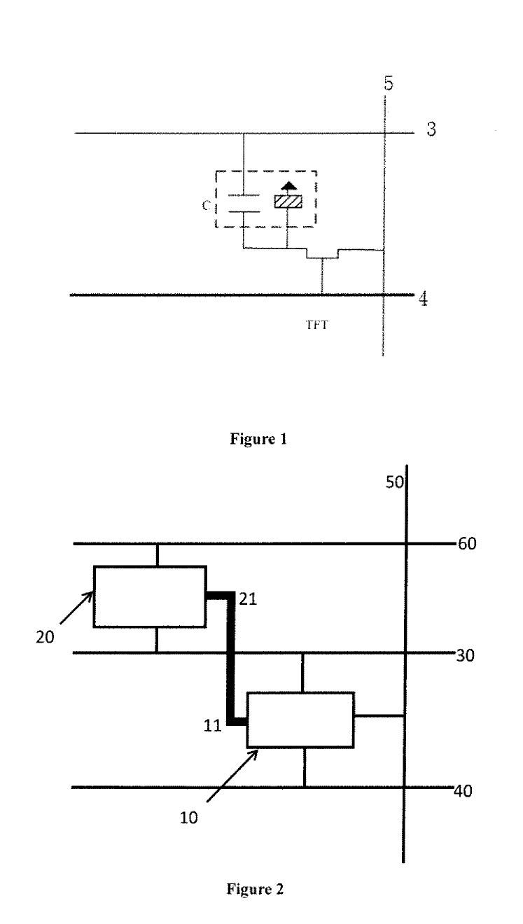

### DETAILED DESCRIPTION

In an embodiment of the present invention, a pixel circuit is provided for eliminating the display time difference between the first gate line and the last gate line while the scan is driven, so that the problem of unsmooth display caused by the time difference in displaying the images can be solved, and the quality of the 3D and moving images can be improved.

The technical solutions of the embodiments of the invention will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention. In a pixel circuit according to an embodiment of the invention, the time difference of approximate one frame between a first charge pixel gate connected to a first pixel unit and a last charge gate line connected to a last pixel unit can be reduced by activating a common gate line after the scan for a last gate line is completed, so that the images can be simultaneously displayed by the first pixel unit to the last pixel unit.

A pixel circuit and a driving method of the pixel circuit provided in embodiments of the present invention will be described by an example of a Full High Definition (FHD) product. A pixel circuit according to an embodiment of the invention comprises a plurality of pixel units; each pixel unit has a cache module 10, a pixel circuit module 20, a common gate line 30, a charge gate line 40, a data line 50, and a common electrode line 60. As shown in FIG. 2, each pixel unit is connected to the common gate line 60. Each pixel unit of the pixel circuit comprises a cache module 10 and a pixel circuit module 20.

The cache module 10 is connected to the charge gate line 40, and the charge gate line 40 supplies a control signal for the cache module 10; an input of the cache module is connected to the data line 50, at the time of supplying a enable control signal by the charge gate line 40, the cache module 10 receives and stores a display signal supplied by the data line 50; the cache module 10 is connected to the common electrode line 30 that supplies a constant voltage signal.

The pixel circuit module 20 is connected to a common gate line 60, each pixel circuit module 20 is connected to the common gate line 60, and the common gate line 60 supplies a control signal for the pixel circuit module 20; an input 21 of the pixel circuit module 20 is connected to an output 11 of the cache module 10, at the time of supplying a enable control signal by the common gate line 60, the display signal stored in the cache module 10 is input to the pixel circuit module 20; the pixel circuit module 20 is connected to the common electrode line 30, and the common electrode line 30 supplies a constant voltage signal for the pixel circuit module 20.

In the pixel circuit provided in the invention described above, the scan is started from the first charge gate line 40 to the last charge gate line 40 sequentially, the display signal is input to the cache module 10 through the data line 50; after the scan for the last charge gate line 40 is completed, the common gate line 60 is activated. Because the common gate line 60 is connected to all of the pixel units, and the display signal stored in the cache module 10 is simultaneously input to the pixel circuit module 20 for displaying, so that the image can be simultaneously displayed by all the pixel units of the charge gate lines from the first charge gate line 40 to the last charge gate line 40 can simultaneously display, and the display time difference of approximate one frame between the first charge gate line 40 and the last charge gate line 40 can be eliminated.

Other pixel circuit and its driving method provided in embodiments of the invention are described as follow.

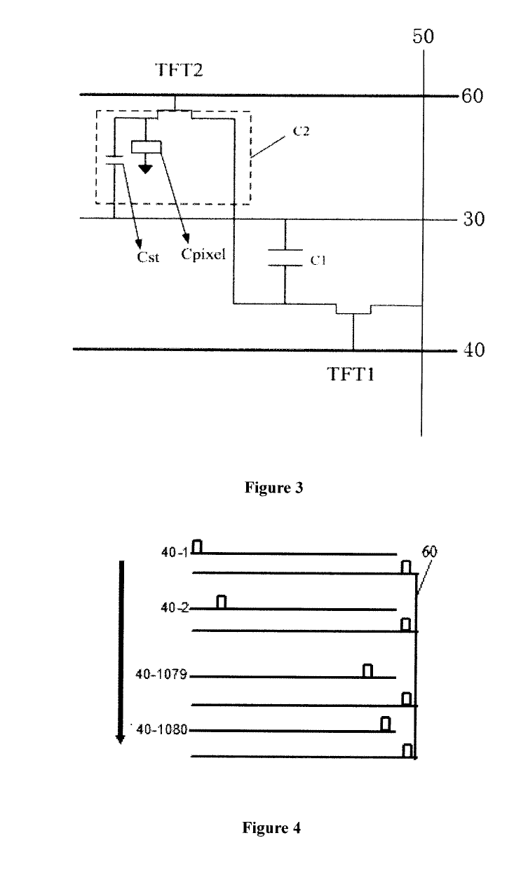

As shown in FIG. 3, the cache module 10 of each pixel unit comprises a first thin film transistor TFT1 and a first capacitor C1, and the pixel circuit module 20 comprises a second thin film transistor TFT2 and a second capacitor C2. The second capacitor C2, for example, comprises a pixel capacitor Cpixel and a common capacitor Cst. A gate electrode of the first thin film transistor TFT1 is connected to the charge gate line 40 that supplies a control signal; a source electrode of the first thin film transistor TFT1 is connected to the data line 50 that supplies a display signal; a drain electrode of the thin film transistor TFT1 is connected to one end of the first capacitor C1, at the time of supplying a enable control signal by the charge gate line 40, the source and drain electrodes of the first thin film transistor TFT1 are electrically conducted, and the display signal input by the data line 50 is stored in the first capacitor C1 through the drain electrode of the TFT1; the other end of the first capacitor C1 is connected to the common electrode line 30 that supplies a constant voltage signal; a gate electrode of the second thin film transistor TFT2 is connected to a common gate line 60, and the common gate line 60 supplies a control signal for the TFT2; a source electrode of the second thin film transistor TFT2 is connected to the drain electrode of the first thin film transistor TFT1,namely, connected to the output of the first capacitor C1; a drain electrode of the second thin film transistor TFT2 is connected to one end of the second capacitor C2, at the time of supplying a enable control signal by the common gate line 60 for the TFT2,the source and the drain electrodes of the second thin film transistor TFT2 is electrically conducted, and the display signal stored in the first capacitor C1 is written into the second capacitor C2 through the source and the drain electrodes of the TFT2 so as to be displayed; the other end of the second capacitor C2 is connected to the common electrode line 60 that supplies a constant voltage signal for the second capacitor C2.

In the pixel circuit provided in the embodiment of the present invention described above, as shown in FIG. 4, the scan is started from the first charge gate line 40-1 to the last gate line (40-1080) sequentially along the direction of the arrow shown in FIG. 4; the display signal from the data line 50 is input and stored in the first capacitor C1 through the first thin film transistor TFT1; after the scan for the last charge gate line 40-1080 is completed, the common gate line 60 is activated. Because the common gate line 60 is connected to the second thin film transistors TFT2 in all the pixel units, and the display signal stored in the first capacitor C l is simultaneously input to the second capacitor C2 through the second thin film transistor TFT2 so as to be displayed, so that all the pixel units of the charge gate lines from the first one 40-1 to the last one 40-1080 can simultaneously display, thus, the display time difference of approximate one frame between the first charge gate line 40-1 and the last charge gate line 40-1080 can be eliminated, the problem of unsmooth display caused by the display time difference can be solved, and the quality of the 3D and moving images can be improved.

With reference to FIG. 4, a driving process of a pixel circuit of an embodiment of the invention will be described by an example of a FHD product with 1080 gate lines.

When the image is displayed, the scan is started from the first charge gate line 40-1 to the 1080 th charge gate line 40-1080 sequentially, after the scan for the respective charge gate lines is completed, the common gate line is activated, so that a complete one frame image can be displayed.

When the signals are applied, the charging is started from the first charge gate line 40-1 to the 1080th charge gate line 40-1080 sequentially , the display signal from the data line 50 is stored in the first capacitor C1 through the first thin film transistor TFT1; when the pixel unit which corresponds to the last charge gate line (the 1080th gate line) has finished storing the display signal in its first capacitor C1, namely, when the charging for the first capacitor C1 which corresponds to the last gate line is completed, the common gate line 60 is activated for electrically conducting the second thin film transistor TFT2 of respecitive pixel units, and the first and second capacitor C1, C2 of the respective pixel units share the signal with each other, and at the same time, it startes to charge the second capacitor C2 of the respective pixel units. Thus, all the pixel units of the charge gate lines from the first one to the last one can simultaneously display the image, so that the time difference caused by a successive scan from the first charge gate line to the last charge gate line can be eliminated, and a complete one frame image can be displayed.

Wherein the first capacitor C1 for storing signals stores the signal from the data line driver IC; the second capacitor C2 for displaying images is the pixel portion for adjusting the amount of transmitted light. Before the second thin film transistor TFT2 is driven, the display signal of the previou frame is stored in the second capacitor C2. After the second thin film transistor TFT2 is driven, the second capacitor C2 has the display signal of the current frame. In terms of the input display signal of the data line driver IC, after the second thin film transistor TFT2 is driven, the display voltage of the current frame in the second capacitor C2 is caculated by the following fomulas:

Q1=C×Vd

Qpixel=Cpixel×Vd−1′

Qtotal=C1×Vd+Cpixel×Vd−1′=Vd′(C1+Cpixel)

Vd′=(C1×Vd+Cpixel×Vd−1′)/(C1+Cpixel)

Wherein Q1 is the electric quantity of the first capacitor, Vd is the voltage of the data line driver IC, Qpixel is the electric quantity of the pixel capacitor, Vd−1′ is the display voltage of the previous frame, Qtotal is the sum of the electric quantity of the first capacitor and the electric quantity of the second capacitor, Vd′is the final voltage after the second thin film transistor TFT2 is on work, and Cpixel represents a pixel capacitor.

In accordance with the display principle described above, the derivation process of the display voltage Vd′ of the current frame can be obtained.

Further, it also can be obtained from the display principle described above that the first capacitor C1 is used for storing signals, the second capacitor C2 is used for display images, and the display signal in the second capacitor C2 is input by the first capacitor C1. According to the capacitor property, the first capacitor C1 is greater than the second capacitor C2, thus the pixel capacitor Cpixel in the second capacitor can display images normally. Therefore, it is also obtained that the first capacitor C1 is greater than the second capacitor C2.

Hereinafter, a driving method of a pixel circuit of an embodiment of the invention will be described.

The driving method comprises:

Step 1, charging a cache module of the respective pixel units sequentially, and simultaneously storing a display signal input by a data line in the cache module of each pixel unit;

Step 2, after the charge for all the cache modules is completed, activating a common gate line, inputting the display signal stored in the cache module to a pixel circuit module of the respective pixel units, and displaying.

For example, the driving method of the pixel circuit provided in an embodiment of the invention comprises:

The step 1, scanning the respective charge gate lines sequentially, inputting the display signal to the first thin film transistor in the cache module of the respective pixel units by the data line, and storing the display signal in the corresponding first capacitor.

The step 2, after the scan for the last charge gate line is completed, namely, after the charge for the last pixel unit is completed, activating the common gate line, due to the common gate line connected to the pixel circuit module of each pixel unit, at this moment, inputting the display signal stored in the first capacitor to the second capacitor of the pixel circuit module of each pixel unit, and displaying. At this moment, all the pixel units from the first pixel unit of the first gate line to the last pixel unit of the last gate line can simultaneously display;

Thus, the display for one frame is completed, and a moving image can be displayed by cycling such a process.

In the above-described embodiments, the first capacitor is used, for example, for storing display signals, and the second capacitor is used, for example, for displaying images.

By using the above-described driving method, the time difference, i.e. approximate one frame, between the first charge pixel gate and the last charge gate line can be reduced, so that a complete one frame image can be simultaneously displayed, the images can be displayed smoothly, and the quality of the 3D and moving images can be improved.

According to an embodiment of the invention, there is further provided a display device, comprising the above-described pixel circuit.

According to an embodiment of the invention, there is further provided a display method of a display device, comprising the above-described driving method.

According to an embodiment of the invention, there is further provided a display device in which the above-described pixel circuit and the driving method thereof are applied. An example of the display device is a liquid crystal display device, in which a pixel electrode in each pixel unit acts to apply an electric field for controlling the rotation degree of the liquid crystal material, so as to conduct a display operation. In some examples, the liquid crystal display device further comprises a backlight source used to provide backlight for the array substrate. Another example of the display device is an organic electroluminescent display device, in which a pixel electrode in each pixel unit of the TFT array substrate functions as an anode or a cathode for driving an organic light emitting material to emit light, so as to conduct a display operation. In other embodiments, the display device can also be an electrophoretic display device.

According to the above description, the embodiments of the present invention can provide at least the following structures and methods:

(1) A pixel circuit, comprising a plurality of pixel units, wherein each pixel unit comprises a data line, a charge gate line, a common electrode line, a cache module, a pixel circuit module, and a common gate line;

the cache module is connected to the charge gate line that supplies a control signal for the cache module;

an input of the cache the module is connected to the data line, at the time of supplying a enable control signal by the charge gate line, the cache module receives and stores a display signal supplied by the data line;

the pixel circuit module is connected to the common gate line that supplies a control signal for the pixel circuit module;

an output of the cache module is connected to an input of the pixel circuit module, at the time of supplying an enable control signal by the common gate line, the display signal stored in the cache module is written into the pixel circuit module.

(2) The pixel circuit according to (1), wherein:

the cache module comprises a first thin film transistor and a first capacitor, a gate electrode of the first thin film transistor is connected to the charge gate line, a source electrode of the first thin film transistor is connected to the data line, and a drain electrode of the first thin film transistor is connected to one end of the first capacitor, the other end of the first capacitor is connected to the common electrode line;

The pixel circuit module comprises a second thin film transistor and a second capacitor, a gate electrode of the second thin film transistor is connected to the common gate line, and a source electrode of the second thin film transistor is connected to the drain electrode of the first thin film transistor, a drain electrode of the second thin film transistor is connected to one end of the second capacitor, and the other end of the second capacitor is connected to the common electrode line.

(3) The pixel circuit according to (2), wherein:

the second capacitor comprises: a pixel capacitor and a common capacitor.

(4) The pixel circuit according to (2) or (3), wherein:

the capacitance value of the first capacitor is greater than that of the second capacitor.

(5) A driving method of the pixel circuit according to any one of (1) to (4), comprising:

charging the cache module of the respective pixel units sequentially, and simultaneously storing the display signal input by the data line in the cache module;

after the charge for all the cache modules is completed, activating the common gate line, inputting the display signal stored in the cache module to the pixel circuit module of each pixel unit, and displaying.

(6) The driving method according to (5), wherein the step of charging the cache module of the respective pixel units sequentially, and simultaneously storing the display signal input by the data line in the cache module comprises:

scanning the charge gate line of the respective pixel units sequentially, inputting the display signal to the first thin film transistor in the cache module by the data line, and storing the display signal in the first capacitor.

(7) The driving method according to (5) or (6), wherein the step of after the charge for all the cache modules is completed, activating the common gate line, inputting the display signal stored in the cache module to the pixel circuit module of each pixel unit, and displaying comprises:

after a scan for a last charge gate line is completed, activating the common gate line, and inputting the display signal stored in the first capacitor to the second capacitor in the pixel circuit module of each pixel unit so as to be displayed.

(8) The driving method according to (6) or (7), wherein:

The capacitance value of the first capacitor is greater than that of the second capacitor.

(9) A display device, comprising the pixel circuit according to any one of (1) to (4).

(10) A display method of the display device, comprising the display method according to any one of (5) to (8).

In the pixel circuit and the driving method thereof provided in the embodiments of the invention, the scan is started from the first charge gate line to the last charge gate line sequentially, and the display signal are stored in the cache module. After the scan for the last charge gate line is completed, the common gate line is activated, thus, the display signal stored in the cache module is input to the pixel circuit module. At this moment, all the pixel units of the charge gate lines from the first one to the last one can simultaneously display, so that the display time difference between the first charge gate line and the last charge gate line caused by a successive scan can be eliminated, the problem of unsmooth display caused by the display time difference can be solved, and the quality of the 3D and moving images can be improved.

While the invention has been illustrated in above general description and specific embodiments, it is apparent that, on the basis of the invention, the skilled person in the art is capable of making modifications or improvements without departing from the spirit of the invention, and these modifications or improvements should belong to the claimed scope of the invention

1. A pixel circuit, comprising a plurality of pixel units, wherein each pixel unit comprises a data line, a charge gate line, a common electrode line, a cache module, a pixel circuit module, and a common gate line;
the cache module is connected to the charge gate line that supplies a control signal for the cache module;
an input of the cache the module is connected to the data line, at the time of supplying a enable control signal by the charge gate line, the cache module receives and stores a display signal supplied by the data line;
the pixel circuit module is connected to the common gate line that supplies a control signal for the pixel circuit module; and
an output of the cache module is connected to an input of the pixel circuit module, and at the time of supplying an enable control signal by the common gate line, the display signal stored in the cache module is written into the pixel circuit module.

2. The pixel circuit according to claim 1, wherein:
the cache module comprises a first thin film transistor and a first capacitor, a gate electrode of the first thin film transistor being connected to the charge gate line, a source electrode of the first thin film transistor being connected to the data line, a drain electrode of the first thin film transistor being connected to one end of the first capacitor, and the other end of the first capacitor being connected to the common electrode line; and
the pixel circuit module comprises a second thin film transistor and a second capacitor, a gate electrode of the second thin film transistor being connected to the common gate line, a source electrode of the second thin film transistor being connected to the drain electrode of the first thin film transistor, a drain electrode of the second thin film transistor being connected to one end of the second capacitor, and the other end of the second capacitor being connected to the common electrode line.

3. The pixel circuit according to claim 2, wherein:
the second capacitor comprises a pixel capacitor and a common capacitor.

4. The pixel circuit according to claim 2, wherein:
the capacitance value of the first capacitor is greater than that of the second capacitor.

5. A driving method of the pixel circuit according to claim 1, comprising:
charging the cache module of the respective pixel units sequentially, and simultaneously storing the display signal input by the data line in the cache module; and
after the charge for all the cache modules is completed, activating the common gate line, inputting the display signal stored in the cache module to the pixel circuit module of each pixel unit, and displaying.

6. The driving method according to claim 5, wherein charging the cache module of the respective pixel units sequentially and simultaneously storing the display signal input by the data line in the cache module comprises:
scanning the charge gate line of the respective pixel units sequentially, inputting the display signal to the first thin film transistor in the cache module by the data line, and storing the display signal in the first capacitor.

7. The driving method according to claim 5, wherein after the charge for all the cache modules is completed, activating the common gate line, inputting the display signal stored in the cache module to the pixel circuit module of each pixel unit, and displaying comprises:
after a scan for a last charge gate line is completed, activating the common gate line, and inputting the display signal stored in the first capacitor to the second capacitor in the pixel circuit module of each pixel unit so as to be displayed.

8. The driving method according to claim 6, wherein:
the capacitance value of the first capacitor is greater than that of the second capacitor.

9. A display device, comprising the pixel circuit according to claim 1.

10. (canceled)

11. The pixel circuit according to claim 3, wherein:
the capacitance value of the first capacitor is greater than that of the second capacitor.

12. The driving method according to claim 6, wherein after the charge for all the cache modules is completed, activating the common gate line, inputting the display signal stored in the cache module to the pixel circuit module of each pixel unit, and displaying comprises:
after a scan for a last charge gate line is completed, activating the common gate line, and inputting the display signal stored in the first capacitor to the second capacitor in the pixel circuit module of each pixel unit so as to be displayed.

13. The driving method according to claim 7, wherein:
the capacitance value of the first capacitor is greater than that of the second capacitor.

14. The driving method according to claim 12, wherein:
the capacitance value of the first capacitor is greater than that of the second capacitor.
